(19) United States
(12) Patent Application Publication
(10) Pub. No.: US 2022/0327713 A1
(43) Pub. Date: Oct. 13, 2022

(54) AUTOMATIC DIGITAL ROCK SEGMENTATION

(71) Applicant: Halliburton Energy Services, Inc., Houston, TX (US)

(72) Inventor: Andre de Almeida Maximo, Rio de Janeiro (BR)

(21) Appl. No.: 17/227,005

(22) Filed: Apr. 9, 2021

(51) Int. Cl. G06T 7/174; G06N 20/00; E21B 47/002; G06N 3/08; E21B 47/003; G06T 7/11

(52) U.S. Cl. CPC G06T 7/174; G06N 20/00; E21B 47/0025; G06N 3/08; E21B 47/003; G06T 7/11; G06T 2207/30181

(57) ABSTRACT

System and methods of automatic digital rock segmentation are provided. A deep learning model may be trained to segment images of reservoir rock. The training may involve the use of first image data of reservoir rock samples and first segmentation data mapping an intensity of image elements of the first image data to one of a plurality of output channels that respectively represent a characterization of reservoir rock. Second image data of a new reservoir rock sample may be obtained, and an intensity of image elements of the second image data may be determined. Using the trained deep learning model, second segmentation data may be generated that maps the intensity of each image element in the second image data to a corresponding one of the plurality of output channels. The trained deep learning model may output a characterization of the new reservoir rock sample based on the second segmentation data.

### FIELD OF THE DISCLOSURE

The present disclosure relates generally to characterization of a reservoir rock sample (e.g., a core sample or plug sample) and particularly, to automatic digital segmentation of image data of the sample using a trained deep learning model.

### BACKGROUND

To characterize a subsurface reservoir formation, a rock sample (e.g., a core sample or a plug sample) may be extracted from the formation. Once extracted, properties of the sample may be measured and scaled (e.g., extrapolated) to estimate properties of the reservoir formation. In some cases, the properties of the sample may be determined or measured based on physical manipulations of the sample. For instance, portions of the sample may be removed, cut, sanded, treated, and/or the like to determine a porosity of the sample, a distribution of minerals within the sample, or a distribution of porous media within the sample, among other properties. Such physical manipulations may limit the usability and/or lifespan of the core sample, as they may alter or otherwise make the core sample unsuitable for further testing or analysis. Further, acquisition of a subsequent core sample for additional testing may be costly in terms of time and resources (e.g., drilling equipment).

Accordingly, in some cases, the properties of the sample may be determined based on images (e.g., imaging data) of the sample. For instance, computed tomography (CT) images may depict internal features of the sample without requiring those features to be physically exposed (e.g., via cutting or sanding), which may extend the lifetime of the core sample. However, identification of specific features, such as pores, porous medium, or minerals within such images may be time-consuming and difficult. Additionally, variations between imaging conditions, including differences in equipment used to obtain images of a rock sample, may result in the same or similar features of the physical rock being depicted inconsistently across different images of the same sample.

### BRIEF DESCRIPTION OF THE DRAWINGS

FIG. 1 is a diagram of an illustrative drilling system in which embodiments of the present disclosure may be implemented.

FIG. 2A is an image of a reservoir rock sample, in accordance with embodiments of the present disclosure.

FIG. 2B is the image of the reservoir rock sample in FIG. 2A after being segmented into multiple channels corresponding to different regions of reservoir rock, in accordance with embodiments of the present disclosure.

FIG. 3 is a block diagram of an illustrative system in which embodiments of the present disclosure may be implemented.

FIG. 4 is a flowchart of an illustrative process for automatic digital rock segmentation using a deep learning model, in accordance with embodiments of the present disclosure.

FIG. 5 is a flowchart of an illustrative process for training a deep learning model, in accordance with embodiments of the present disclosure.

FIG. 6A is a segmented multi-channel image of a reservoir rock sample, in accordance with embodiments of the present disclosure.

FIGS. 6B-6C illustrate binary images respectively corresponding to a particular channel of the segmented multi-channel image of FIG. 6A, in accordance with embodiments of the present disclosure.

FIG. 7A is a multi-channel image of a reservoir rock sample, in accordance with embodiments of the present disclosure.

FIGS. 7B-7C illustrate binary images respectively corresponding to a particular channel of the multi-channel image of FIG. 7A, in accordance with embodiments of the present disclosure.

FIG. 8 is a block diagram of an illustrative computer system in which embodiments of the present disclosure may be implemented.

### DESCRIPTION OF ILLUSTRATIVE EMBODIMENTS

Embodiments of the present disclosure relate to automatic digital segmentation of reservoir rock samples, such as a core or a plug sample. More specifically, the present disclosure relates to digital segmentation of the reservoir rock samples using a deep learning model (e.g., a machine learning algorithm), such as a three-dimensional (3D) U-net model. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to implement such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment.” “an embodiment.” “an example embodiment.” etc., indicate that the embodiment described may include a particular feature, structure, or characteristic, but every embodiment may not necessarily include the particular feature, structure, or characteristic. Moreover, such phrases are not necessarily referring to the same embodiment.

As will be described in further detail below, embodiments of the present disclosure may be used to segment (e.g., classify) regions of an image of a reservoir rock sample, such as a core sample or a plug sample, using a deep learning model (e.g., a machine learning algorithm). More specifically, embodiments, of the present disclosure relate to training and using a deep learning model, such as a neural network, to automatically segment an image of a reservoir rock sample into different channels (e.g., classes and/or labels). The different channels may include a channel corresponding to a mineral (e.g., a mineral channel), a channel corresponding to a porous medium (e.g., a porous medium channel), a channel corresponding to a pore (e.g., a pore channel), and/or the like. In this regard, the segmentation of an image of a reservoir rock sample may involve indicating that a region of the image depicting a mineral is associated with the mineral channel, a region of the image depicting a porous medium (e.g., a porous phase) is associated with the porous medium channel, a region of the image depicting a pore is associated with the pore channel, and/or the like. Moreover, automatically segmenting the image with the deep learning model may involve segmenting the image without user intervention (e.g., without a user input and/or without a user-designated segmentation).

In some embodiments, the automatic segmentation of image data by the deep learning model may map and/or convert intensities (e.g., pixel intensities and/or pixel values) within an image (e.g., image data) to a particular channel. The intensities may correspond to a measure of signal intensity associated with an image element (e.g., a pixel and/or a voxel) of the image data and/or a level of brightness associated with the image element in a grayscale or color image of the image data. As an illustrative example of the intensity mapping, an image element (e.g., a region of the image), such as a pixel and/or a voxel, with a relatively higher intensity (e.g., within a first range of intensity values or “first intensity range”) may be characterized (e.g., segmented) as being associated with a first channel (e.g., a mineral channel), while an image element with a relatively lower intensity (e.g., within a second intensity range) may be characterized as being associated with a second channel (e.g., a pore channel). Continuing with the above example, an image element with an intensity falling between the first and second intensity ranges associated with the respective mineral and pore channels may be characterized as being associated with a third channel (e.g., a porous medium channel). It should be appreciated that the third channel may be associated with a third intensity range with intensity values falling between those associated with the first and second ranges of the respective first and second channels. Moreover, in some embodiments, the segmentation by the deep learning model may account for variations in intensities of similar features (e.g., minerals, pores, porous medium, and/or the like) between different images, which may result from differences in equipment and/or imaging modalities used to obtain the images, for example. To that end, the deep learning model may perform the segmentation such that a first image of a rock sample obtained under first conditions (e.g., using first equipment) may be segmented with substantially the same results (e.g., output channels) as a second image of the rock sample obtained under second conditions (e.g., using second equipment).

Further, in some embodiments, the segmentation generated by the deep learning model may be provided as a set of binary images, where the set includes a different binary image for each channel included in the segmentation. For instance, for an image with a region characterized as depicting a mineral and a region characterized as depicting a pore, the segmentation may include a first binary image corresponding to the mineral channel and a second, different binary image corresponding to the pore channel. Additionally or alternatively, the segmentation and/or a characterization of the image data may be used to provide one or more metrics associated with the reservoir rock sample. For instance, the segmentation may be used to provide an indication of a distribution of pores, minerals, and/or porous medium in the reservoir rock sample, a size of the pores, minerals, and/or porous medium in the reservoir rock sample, a model of the reservoir rock sample, and/or the like. In this regard, the indication may be a numerical indication, a graphical indication, a textual indication, or a combination thereof. Moreover, in some embodiments, the indication may be used to model and/or simulate further properties of the reservoir rock sample. For instance, fluid flow through the reservoir rock sample may be simulated based on the indication.

In some embodiments, training the deep learning model may involve obtaining to training image data, as well as training segmentation data associated with the training image data. The training image data may include images of reservoir rock samples, and the training segmentation data may include a respective segmentation (e.g., designations of channels) associated with each of the images. In some embodiments, for a particular image of the training image data, the training segmentation data may include a composite image that includes one or more segmentations (e.g., channel outputs). In such embodiments, the composite image may be separated into a set of binary images, where the set includes a different binary image for each channel output. In some embodiments, for a particular image of the training binary image, the training segmentation data may include a set of binary images respectively corresponding to a particular channel of the particular image. In such embodiments, the training segmentation data may not be further separated. In any case, training the deep learning model may involve training the deep learning model based on associations between the training image data and the training segmentation data. That is, for example, the deep learning model may be trained based on a mapping between an input training image of the training image data and an output of an associated training segmentation data (e.g., channel outputs associated with the input image). Thus, in some embodiments, the deep learning model may be trained via supervised learning. Moreover, in some embodiments, the training of the deep learning model may be validated by a user (e.g., via a user input) and/or based on a set of validation data, and the deep learning model may be retrained and/or the training of the deep learning model may be adjusted based on the validation.

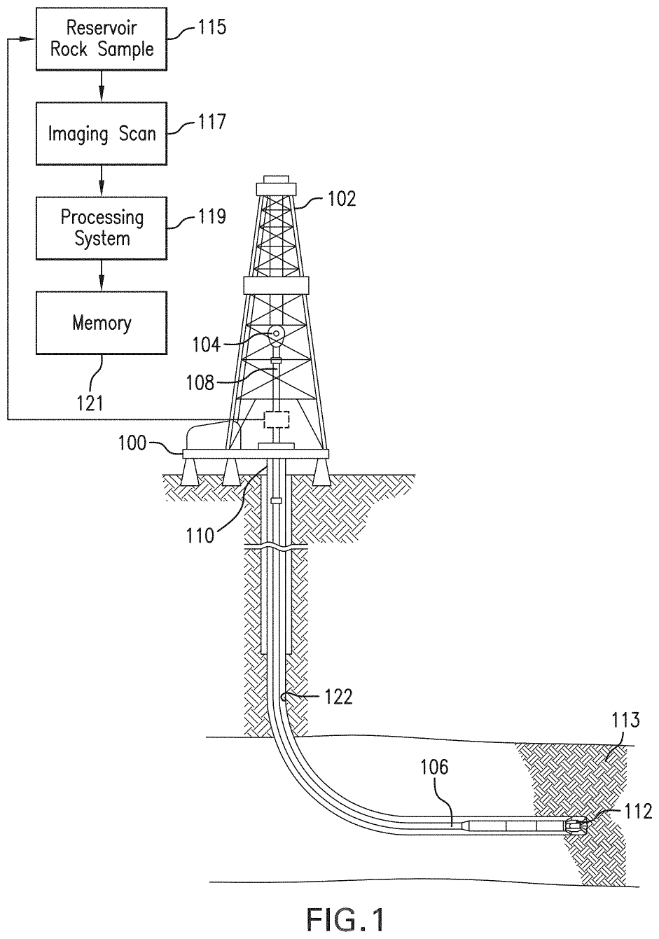

Illustrative embodiments and related methodologies of the present disclosure are described below in reference to FIGS. 1-8 as they might be employed in, for example, a computer system for well planning. Advantages of the disclosed automatic digital rock segmentation techniques include, for example and without limitation, characterization of reservoir rock samples and, as a result, of a reservoir with greater consistency and/or accuracy. For instance, the disclosed automatic segmentation may reduce user errors associated with manual segmentation. Further, by digitally segmenting a rock sample, the rock sample may be characterized without physically manipulating (e.g., removing portions of, cutting, sanding, treating, and/or the like) the rock sample itself. In this regard, the same rock sample may be used repeatedly and/or for a number of different simulations. In this way, the number of rock samples retrieved from a reservoir, which may involve a costly and time-intensive process, may be reduced.

Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a diagram of an illustrative drilling system. In accordance with the present disclosure, the drilling system may be used to retrieve a reservoir rock sample, such as a core sample, for characterization of a reservoir. As shown in FIG. 1, a drilling platform 100 is equipped with a derrick 102 that supports a hoist 104. Drilling in accordance with some embodiments is carried out by a string of drill pipes connected together by “tool” joints so as to form a drill string 106. Hoist 104 suspends a top drive 108 that is used to rotate drill string 106 as the hoist lowers the drill string through wellhead 110. Connected to the lower end of drill string 106 is a reservoir rock sample collection tool 112, such as a drill bit and/or a coring tool. The reservoir rock sample collection tool 112 may retrieve a reservoir rock sample by cutting (e.g., drilling) the sample from a reservoir formation 113 and/or any other suitable method to extract the sample. In some embodiments, the sample may be cut from a side of the wellbore 122. Further, in some embodiments, to drill and/or cut the sample, the reservoir rock sample collection tool 112 is rotated and collection of the sample and/or drilling of a wellbore 122 is accomplished by rotating drill string 106, e.g., by top drive 108 or by use of a downhole “mud” motor (not shown) near reservoir rock sample collection tool 112 (e.g., drill bit) that turns the tool or by a combination of both top drive 108 and a downhole mud motor. Further, in some embodiments, a hollow chamber may be connected to the lower end of the drill string 106 such that a reservoir rock sample cut and/or drilled by the reservoir rock sample collection tool 112 may be extracted into the hollow chamber and subsequently retrieved from the wellbore 122 (e.g., via retrieval of the hollow chamber and/or the drill string 106).

Thus, as illustrated, the reservoir rock sample 115 may be retrieved (e.g., collected) from the wellbore 122 and/or reservoir formation 113. In some embodiments, the reservoir rock sample 115 may be a core sample or a plug sample. As described herein, the term core sample may refer to a reservoir rock sample retrieved directly from a wellbore (e.g., wellbore 122) and/or reservoir formation. In some embodiments a core sample may be generally cylindrical in shape. Moreover, a core sample may include first dimensions (e.g., a first diameter and a first length). In some embodiments, a diameter and/or a length of the core sample may be on the order of tens to hundreds of feet. Further, as described herein, the term plug sample may refer to a reservoir rock sample taken from a core sample (e.g., after the core sample is removed from the wellbore 122). In some embodiments, a plug sample may include second dimensions different than the first dimensions. For instance, a plug sample may have a diameter and/or length on the order of inches or feet. While particular dimensions are described with reference to core samples and plug samples, embodiments are not limited thereto. In this regard, a core sample or a plug sample may have any suitable dimensions.

As described in greater detail below, a retrieved reservoir rock sample 115 may be used to characterize certain properties of the reservoir formation 113. In some embodiments, for example, the retrieved reservoir rock sample 115 may be analyzed to determine a porosity of the reservoir formation 113, a presence of certain minerals within reservoir formation 113, an expected fluid flow within of the reservoir formation 113 and/or the like. In some embodiments, such analysis may be performed by physically manipulating (e.g., cutting, coring, and/or the like). Additionally or alternatively, the reservoir rock sample 115 may be imaged, and the resulting image data may be analyzed to determine characteristics of the reservoir formation 113. As illustrated, for example, an imaging scan 117 may be performed on the reservoir rock sample 115.

In some embodiments, the imaging scan 117 may capture image data of the reservoir rock sample 115. In some embodiments, the image data may include a sequence of two-dimensional images of the reservoir rock sample 115 that together form three-dimensional image data of the reservoir rock sample 115. Further, the image data may include a computed tomography (CT) image, a magnetic resonance imaging (MRI) image, an ultrasound image, and/or the like. To that end, the imaging scan 117 may be performed by any suitable imaging device. In some embodiments, a computed tomography (CT) imaging device, a microCT imaging device, an MRI imaging device, an ultrasound imaging device, and/or the like may be used to perform the imaging scan 117, for example. In some embodiments, a CT imaging device may be used to capture image data of a reservoir rock sample 115 that is a core sample, while a microCT imaging device may be used to capture image data of a reservoir rock sample 115 that is a plug sample. Further, the microCT imaging device may capture image data of the plug sample with a higher resolution than the image data of the core sample captured by the CT imaging device.

While the reservoir rock sample 115 and imaging scan 117 are illustrated proximate the drilling platform 100, it may be appreciated that the reservoir rock sample 115 may be transported off location for the imaging scan 117. In this regard, the imaging scan 117 may be performed within a laboratory or a separate geographical location from the drilling platform 100 and/or afield location. Additionally or alternatively, the imaging scan 117 may be performed in the field (e.g., proximate the wellsite).

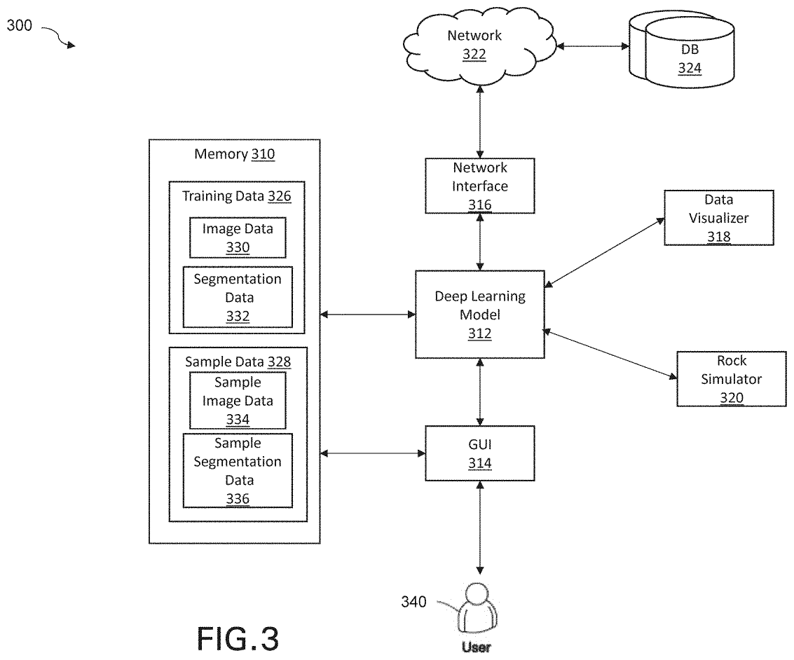

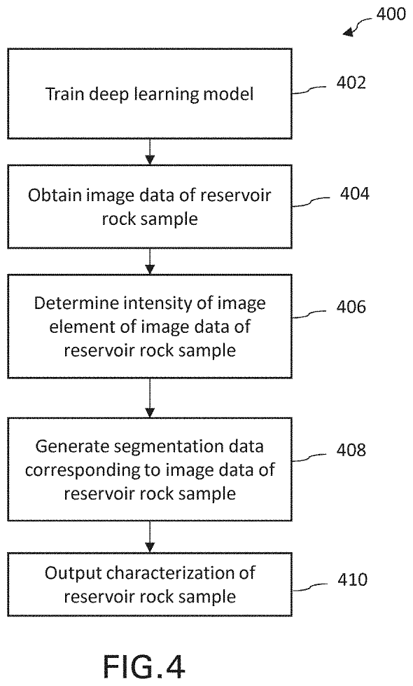

As further illustrated, the results of the imaging scan 117 (e.g., the image data produced by the imaging scan 117) may be provided to a processing system 119 (e.g., a computing system). The processing system 119 may perform one or more of the techniques described herein to characterize the image data of the reservoir rock sample 115 and, as a result, to characterize the reservoir formation 113. In particular, the processing system 119 may use and/or implement a deep learning model (e.g., a machine learning algorithm) to automatically segment the image data, as described below with respect to at least FIGS. 3 and 4.

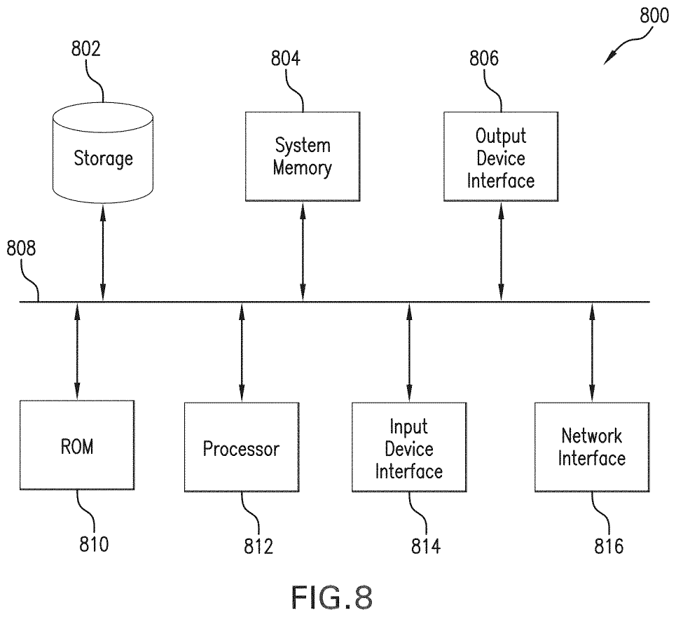

In some embodiments, the processing system 119 may be implemented using any type of processing system, such as computer system 800 of FIG. 8 described below. In some embodiments, the processing system computing device having at least one processor and a memory, such as memory 121.

As illustrated, the processing system 119 may be in communication with a memory 121. The memory 121 may be any suitable data storage device. Additionally or alternatively, the memory 121 may be any type of recording medium coupled to an integrated circuit that controls access to the recording medium. The recording medium can be, for example and without limitation, a semiconductor memory, a hard disk, or similar type of memory or storage device. In some implementations, memory 121 may be a remote data store. e.g., a cloud-based storage location. The memory 121 may be internal to or external to the processing system 119.

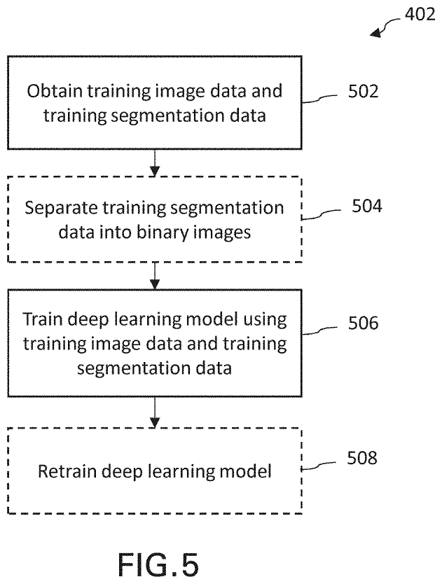

In some embodiments, the memory 121 may include training data suitable to train the deep learning model used by the processing system 119, as described below with reference to FIG. 5. Segmentation data generated by the processing system 119 may further be stored in the memory 121.

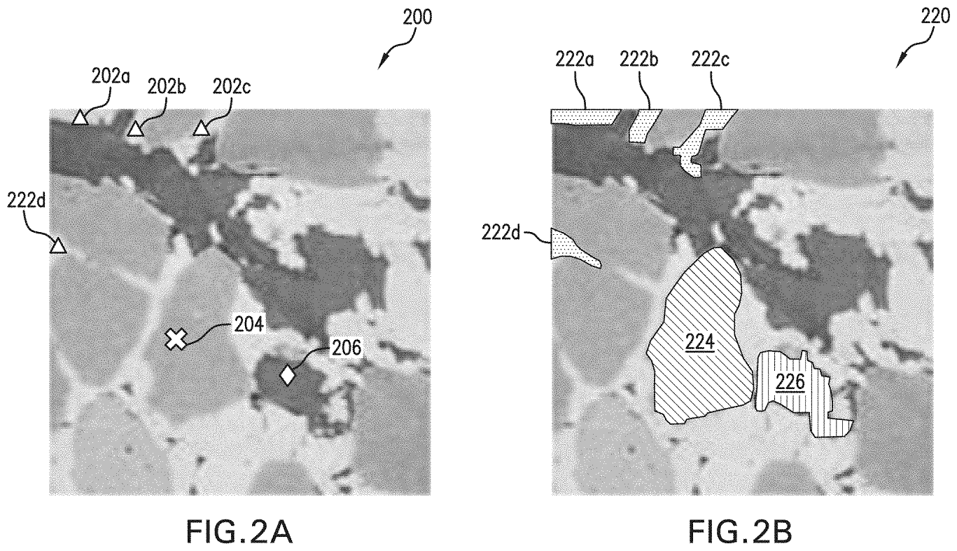

FIG. 2A is an exemplary image 200 of a reservoir rock sample, such as a core sample or a plug sample. In particular, the image 200 is a CT image of a reservoir rock sample. The image 200 includes regions illustrated with different intensities (e.g., shown as different colors within a grayscale coding). In some embodiments, regions with different intensities within an image of a reservoir rock sample, such as image 200, may correspond to different channels, or classes. For instance, an image of a reservoir rock sample may depict a pore, a porous medium, a mineral, and/or the like. As described herein, the term porous medium (e.g., porous phase) can refer to types of rocks with a relatively greater porosity than a mineral. For instance, limestone, sandstone, and/or the like may correspond to the porous medium channel. As described herein, the term pore can refer to empty space (e.g., gaps) within a reservoir rock sample, such as gaps between minerals and/or porous medium. Further, the image 200 may be referred to as a multi-class or multi-channel image, as the image 200 depicts multiple different channels (e.g., multiple classes). To that end, the image 200 depicts at least one pore, porous medium, and mineral, which each correspond to a different channel (e.g., a pore channel, a porous medium channel, and a mineral channel, respectively).

In some embodiments, an image of a reservoir rock sample may be segmented into the different channels included within the image. That is, for example, areas of the image may be classified and/or labeled according to the channel with which they correspond. In some embodiments, such segmentation may be performed based on a user input. For instance, a user may provide an input to select an area (e.g., a point) of the image and to indicate that the area corresponds to a particular channel. With respect to FIG. 2A, for example, a user may provide inputs 202a-d to indicate that the areas corresponding to the inputs 202a-d correspond to a mineral. The input 204 may be provided to indicate an area corresponding to a porous medium, and the input 206 may be provided to indicate an area corresponding to a pore.

In some embodiments, a user input, such as inputs 202a-d, 204, and 206, may be provided at a particular point within an image, as illustrated. In such cases, segmentation of the image may involve identifying an extent of an area including the point that corresponds to a particular channel. For instance, an area with similar properties to the point may be identified as corresponding to the same channel as the point. In some embodiments, to identify the area, image processing may be utilized to identify image elements (e.g., pixels) with a matching or substantially similar intensity as the points that are adjacent to or in communication with the point. In this regard, the segmentation and/or image processing may involve a pixel level analysis. Additionally or alternatively, an area surrounding and/or 1o including the point may be identified based on identification of edges of the area. The edges may be identified based on a difference in intensities between adjacent pixels or lines within an image exceeding a threshold, for example. Moreover, embodiments are not limited to the image processing techniques described herein. In this regard, any suitable segmentation and/or image analysis techniques may be employed to segment an image based on a user input.

FIG. 2B illustrates an image 220 segmented into different channels. More specifically, FIG. 2B corresponds to a segmentation of the image 200 based on the inputs 202a-d, 204, and 206. To that end, the regions 222a-d, which may be identified based on the user inputs 202a-d, are shown as corresponding to the mineral channel via a first fill pattern. The region 224, which may be identified based on the user input 204, is shown as corresponding to the porous medium channel via a second fill pattern, and the region 226, which may be identified based on the user input 206, is shown as corresponding to the pore channel via a third fill pattern.

In some embodiments, a user input for segmentation of an image may additionally or alternatively indicate an outline of an area corresponding to a particular channel. In this regard, the any of the regions 222a-d, 224, or 226 may be determined based on image processing associated with a user input corresponding to a point (e.g., user inputs 202a-d, 204, or 206, respectively) or may be determined based on an outline of the region indicated by a user input. In any case, such segmentation of an image is dependent on a user input, such as an input provided by a geologist. Accordingly, the segmentation illustrated and described with respect to FIGS. 2A-2B may be both time consuming and imprecise (e.g., susceptible to error). For instance, analysis of a reservoir rock sample may be delayed based on the time it takes for a user to perform manual selections (e.g., provide user inputs) within each image of a set of image data corresponding to the sample. To that end, with increasing image data for a reservoir rock sample, the analysis time may also increase. Moreover, because intensities of image elements within images may vary based on the imaging equipment and/or conditions (e.g., resolution, settings, and/or the like) with which the images are obtained, segmentation and/or comparison of image elements across different imaging equipment and/or conditions may be difficult.

Turning now to FIG. 3, a block diagram of an exemplary system 300 for automatic digital characterization (e.g., segmentation) of a reservoir rock sample is illustrated. As shown in FIG. 3, system 300 includes a memory 310, a deep learning model 312, a graphical user interface (GUI) 314, a network interface 316, a data visualizer 318, and a rock simulator 320. In some embodiments, memory 310, deep learning model 312, GUI 314, network interface 316, data visualizer 318, and rock simulator 320 may be communicatively coupled to one another via an internal bus of system 300. Further, in some embodiments, one or more of the components, functions, and/or operations of the system 300 may be included within and/or performed by the processing system 119 and/or the memory 121 of FIG. 1.

System 300 may be implemented using any type of computing device having at least one processor and a memory, such as the processing system 119 of FIG. 1 and/or the system 800 of FIG. 8. The memory may be in the form of a processor-readable storage medium for storing data and instructions executable by the processor. Examples of such a computing device include, but are not limited to, a tablet computer, a laptop computer, a desktop computer, a workstation, a mobile phone, a personal digital assistant (PDA), a set-top box, a server, a cluster of computers in a server farm or other type of computing device. In some implementations, system 300 may be a server system located at a data center associated with the hydrocarbon producing field. The data center may be, for example, physically located on or near the field. Alternatively, the data center may be at a remote location away from the hydrocarbon producing field. The computing device may also include an input/output (I/O) interface for receiving user input or commands via a user input device (not shown). The user input device may be, for example and without limitation, a mouse, a QWERTY or T9 keyboard, a touch-screen, a graphics tablet, or a microphone. The I/O interface also may be used by each computing device to output or present information to a user via an output device (not shown). The output device may be, for example, a display coupled to or integrated with the computing device for displaying a digital representation of the information being presented to the user.

Although only memory 310, deep learning model 312, GUI 314, network interface 316, data visualizer 318, and rock simulator 320 are shown in FIG. 3, it should be appreciated that system 300 may include additional components, modules, and/or sub-components as desired for a particular implementation. It should also be appreciated that memory 310, deep learning model 312, GUI 314, network interface 316, data visualizer 318, and rock simulator 320 may be implemented in software, firmware, hardware, or any combination thereof. Furthermore, it should be appreciated that embodiments of memory 310, deep learning model 312, GUI 314, network interface 316, data visualizer 318, and rock simulator 320, or portions thereof, can be implemented to run on any type of processing device including, but not limited to, a computer, workstation, embedded system, networked device, mobile device, or other type of processor or computer system capable of carrying out the functionality described herein.

As will be described in further detail below, memory 310 can be used to store information accessible by the deep learning model 312 and/or the GUI 314 for implementing the functionality of the present disclosure. While not shown, the memory 310 can additionally or alternatively be accessed by the data visualizer 318, the rock simulator 320, and/or the like. Memory 310 may be any type of recording medium coupled to an integrated circuit that controls access to the recording medium. The recording medium can be, for example and without limitation, a semiconductor memory, a hard disk, or similar type of memory or storage device. In some implementations, memory 310 may be a remote data store, e.g., a cloud-based storage location, communicatively coupled to system 300 over a network 322 via network interface 316 (e.g., a port, a socket, an interface controller, and/or the like). Network 322 can be any type of network or combination of networks used to communicate information between different computing devices. Network 322 can include, but is not limited to, a wired (e.g., Ethernet) or a wireless (e.g., Wi-Fi or mobile telecommunications) network. In addition, network 322 can include, but is not limited to, a local area network, medium area network, and/or wide area network such as the Internet.

As shown in FIG. 3, memory 310 may be used to store a training data 326. The training data 326 may include image data 330 as well as segmentation data 332 (e.g., classification data). In some embodiments, the image data 330 may include images associated with reservoir rock samples, such as core samples and/or plug samples, obtained via a reservoir formation. For instance, the image data 330 may correspond to imaging data output by an imaging scan of a reservoir rock sample, such as imaging scan 117 of FIG. 1. In this regard, the image data 330 may include CT image data or image data corresponding to any suitable imaging modality. Moreover, the image data 330 may include 2D images and/or 3D image data (e.g., a sequence of 2D images). The segmentation data 332 may include one or more segmentations of the image data 330. That is, for example, the segmentation data 332 may segment (e.g., label and/or classify) different areas of images within the image data 330 based on a particular channel associated with the areas. In this regard, segmentation data 332 may map an intensity of an image element (e.g., an area of an image) to a particular output channel, where the output channel represents a characterization of reservoir rock for a corresponding segment of the image data 330. For instance, the segmentation data 332 may identify an area (e.g., an image element) of an image as corresponding to the pore channel, the porous medium channel, the mineral channel, and/or the like. In some embodiments, the segmentation data 332 may be integrated within or separate from the image data 330. For instance, the image data 330 may include segmented images that already include segmentation data 332, such as image 220 of FIG. 2B. Additionally or alternatively, the segmentation data may be stored in association with the image data 330 and/or may be included in metadata (e.g., a header) of the image data 330. Further, in some embodiments, the segmentation data 332 may be generated based on a segmentation procedure involving user inputs, as described above with respect to FIG. 2B, and/or the segmentation data 332 may be generated based on a fully automatic segmentation procedure (e.g., a segmentation procedure that does not require user intervention), as described in greater detail below.

In some embodiments, the training data 326 may additionally or alternatively be obtained from a database, such as database 324. In particular, the training data 326 may be communicated from the database 324 via the network 322 and/or the network interface 316. In some embodiments, for example, the training data 326 may be stored within the memory 310 after it is communicated from the database 324. Database 324 may be any type of data storage device, e.g., in the form of a recording medium coupled to an integrated circuit that controls access to the recording medium. The recording medium can be, for example and without limitation, a semiconductor memory, a hard disk, or similar type of memory or storage device accessible to system 300. Further, as shown in FIG. 3, database 324 may be implemented as a remote database communicatively coupled to system 300 via network 322.

As further illustrated, the system 300 may include sample data 328. The sample data 328 may be stored and/or buffered within the memory 310, for example. In some embodiments, the sample data 328 may include sample image data 334. The sample image data 334 may correspond to image data of a reservoir rock sample, such as reservoir rock sample 115 (FIG. 1). For instance, the sample image data 334 may include one or more images, such as a sequence of images, of the reservoir rock sample. In some embodiments, the images may be CT images of the reservoir rock sample. More specifically, the images may include images of an interior of a reservoir rock sample, as imaged by a CT imaging device.

The sample data 328 may further include sample segmentation data 336. The sample segmentation data 336 may include one or more segmentations of the sample image data 334. That is, for example, the sample segmentation data 336 may segment (e.g., label and/or classify) different areas of images within the sample image data 334 based on a particular channel associated with the areas. In this regard, sample segmentation data 336 may map an intensity of an image element in the sample image data 334 to a particular output channel, where the output channel represents a characterization of the reservoir rock for a corresponding segment of the sample image data 334. For instance, the sample segmentation data 336 may identify an area (e.g., an image element) of an image as corresponding to the pore channel, the porous medium channel, the mineral channel, and/or the like. Moreover, in some embodiments, the sample segmentation data 336 may include a set of binary images. More specifically, the sample segmentation data 336 may include a respective set of binary images for particular images of the sample image data 334. An exemplary set of binary images may include a different binary image for each channel included in an image of the sample image data 334. For instance, for an image having a first region corresponding to the pore channel, a second region corresponding to the porous medium channel, and the mineral channel, the sample segmentation data 336 may include a first binary image depicting the first region, a second binary image depicting the second region, and a third binary image depicting the third region.

In some embodiments, the sample segmentation data 336 may be generated by the deep learning model 312. As described in greater detail below, the deep learning model 312 may generate the sample segmentation data 336 based on the sample image data 334 and the training data 326 (e.g., based on training of the deep learning model 312). Moreover, once generated, the sample segmentation data 336 may be integrated within or maintained separate from the sample image data 334. For instance, the sample segmentation data 336 may be stored in association with the sample image data 334 and/or may be included in metadata (e.g., a header) of the sample image data 334.

In some embodiments, the deep learning model 312 (e.g., a machine learning algorithm) may be implemented as a neural network. In particular, the deep learning model 312 may be implemented to output multiple channels. For instance, the deep learning model 312 may be implemented as a three-dimensional U-Net model with multiple output channels (e.g., a multi-net model). The U-Net model is generally characterized by a “U” shape defined by downsampling an input (e.g., an input image) to different classes (e.g., channels) and then upsampling the data back to an original size (e.g., resolution). In this way, an advantage of implementing the deep learning model 312 as the 3D U-Net model is that a resolution of the output (e.g., one or more output images) of the 3D U-Net model may substantially match a resolution of an input (e.g., an input image) to the model. The deep learning model 312 may additionally or alternatively be implemented as a convolutional neural network (CNN) or any other suitable machine learning algorithm In some embodiments, the deep learning model 312 may be a single model capable of outputting multiple channels. In some embodiments, to output multiple different channels, the deep learning model 312 may include a number of different models (e.g., a different deep learning models). For instance, the deep learning model 312 may include a first model configured to output a first output channel (e.g., associated with segmentation into the first output channel) and a different, second model configured to output a second output channel (e.g., associated with segmentation into the second output channel). The first model and the second model may implemented as the same type of model (e.g., a first 3D U-Net model and a second 3D U-Net model) or as different deep learning models.

In some embodiments, the deep learning model 312 may be trained, using the training data 326, to perform automatic digital rock segmentation. In particular, the deep learning model 312 may be trained to segment image data of reservoir rock samples. For instance, the deep learning model 312 may be trained to automatically segment the sample image data 334, generating sample segmentation data 336. To that end, the deep learning model 312 may be configured to output one or more binary images for a given input image, where each binary image depicts a respective output channel included within the input image. Further details of the automatic digital rock segmentation are provided with respect to FIGS. 4-7.

In some embodiments, the system 300 may output a characterization of the reservoir rock sample (e.g., corresponding to the sample data 328) based on the sample segmentation data 336. In some embodiments, the characterization of the reservoir rock sample may be the sample segmentation data 336 itself. To that end, the system may output binary images or a composite (e.g., multi-channel) image indicating a segmentation of the sample image data 334. In some embodiments, the characterization of the reservoir rock sample may be an indication of a distribution of pores, minerals, and/or porous medium in the reservoir rock sample, a size of the pores, minerals, and/or porous medium in the reservoir rock sample, a model of the reservoir rock sample, and/or the like, which may be determined based on the sample segmentation data 336. The indication may be a numerical indication, a graphical indication, a textual indication, or a combination thereof.

Further, the characterization of the reservoir rock sample may output to and/or by the GUI 314, the data visualizer 318, and/or the rock simulator 320. For instance, the characterization may be output to the GUI 314, which may be provided on a display (e.g., an electronic display). The display may be, for example and without limitation, a cathode ray tube (CRT) monitor, a liquid crystal display (LCD), or a touch-screen display, e.g., in the form of a capacitive touch-screen light emitting diode (LED) display. Further, the data visualizer 318 may be used to generate different data visualizations, such as bar graphs, pie graphs, histograms, plots, charts, numerical indications, textual indications, and/or the like based on the sample segmentation data 336. The data visualizer 318 may further perform any suitable data analysis on the sample segmentation data 336, such as interpolation, extrapolation, averaging, determining a standard deviation, summing or subtracting, multiplying or dividing, and/or the like. Further, in some embodiments, the sample data 328 may include data corresponding to a first reservoir rock sample and a second reservoir rock sample. In such embodiments, the data visualizer 318 may produce a data visualization that facilitates a comparison between the sample segmentation data 336 corresponding to the first and the sample segmentation data 336 corresponding to the second sample. Moreover, the rock simulator 320 may be used to construct a model of the reservoir rock sample based on the sample segmentation data 336. In some instance, the model may be a 2D or a 3D model. To that end, the sample segmentation data 336 may provide 2D data, 3D data, or both. For instance, segmentations of a sequence of images within the sample image data 334 may be used to construct a 3D model. Such a model may approximate a positioning, size, distribution, and/or the like of pores, porous medium, minerals, and/or the like (e.g., features identified by the sample segmentation data 336) within the reservoir rock sample. The rock simulator 320 may further utilize the model to simulate fluid flow within the reservoir rock sample, an effect of different drilling techniques on the reservoir rock sample, and/or the like. Simulation of the reservoir rock with the model may further correspond to simulation of a reservoir formation (e.g., a reservoir formation the sample was obtained from). In this way, sample segmentation data 336 and/or the model of the reservoir rock sample may be used for the purposes of reservoir simulations and well planning.

In some embodiments, GUI 314 enables a user 340 to view and/or interact directly with the characterization of the reservoir rock sample. For example, the characterization (e.g., segmentation data, model, or other numerical, textual, and/or graphical representation) may be displayed in association with the GUI 314 to the user 340. Further, in some embodiments, the user 340 may use a user input device (e.g., a mouse, keyboard, microphone, touch-screen, a joy-stick, and/or the like) to interact with the characterization at the GUI 314. For instance, in some embodiments, the GUI 314 may receive a user input provided by the user 340 via such a device. In particular, a user input may be provided to modify, accept, or reject the sample segmentation data 336. In some embodiments, the sample segmentation data 336 may thus be updated based on a user input. Moreover, in some embodiments, such a user input may alter the training of the deep learning model 312, as described in greater detail below. The GUI 314 may additionally or alternatively receive a user input to generate the model, to generate a particular data visualization (e.g., via the data visualizer 318), to run a particular simulation with the model (e.g., via the rock simulator 320), to adjust a characteristic of the model and/or a data visualization, and/or the like.

While certain components of the system 300 are illustrated as being in communication with one another, embodiments are not limited thereto. To that end, any combination of the components illustrated in FIG. 3 may be communicatively coupled. Further, while segmentation of a reservoir rock sample is described herein with respect to three output channels—namely a pore channel, a porous medium channel, and a mineral channel, any number of output channels may be used to segment (e.g., characterize) image data of a reservoir rock sample. To that end, an additional channel may be added, a channel may be omitted, and/or the like. As an illustrative example, in some embodiments, different minerals may correspond to respective channels. For instance, a segmentation may include a first channel for a first mineral type and a second channel for a second mineral type. Further the mineral types may refer to specific minerals, such as quartz, or classes of minerals, such as siliceous cements, carbonate minerals or clay minerals. Moreover, in some embodiments, the channels available as outputs within a segmentation procedure may be selectively designated. For instance, a user input may be received at the GUI 314 indicating the output channels for a segmentation of an image.

FIG. 4 is a flowchart of an illustrative process 400 for automatic digital rock segmentation using a deep learning model. For discussion purposes, process 400 will be described with reference to FIG. 1 and the system 300 of FIG. 3. However, process 400 is not intended to be limited thereto.

In block 402, the process 400 involves training a deep learning model (e.g., a machine learning algorithm), such as deep learning model 312 of FIG. 3. As described with respect to FIG. 3, the deep learning model may be configured to output multiple channels (e.g., multiple classes). In this regard, the deep learning model may be a 3D U-Net model. Further, training the deep learning model may involve training the deep learning model to perform automatic digital rock segmentation. In particular, training the deep learning model may involve using training data (e.g., training data 326) to train the deep learning model to segment image data of a reservoir rock sample. In this regard, training the deep learning model may involve training the deep learning model to segment digital images of reservoir rock using image data of a set of reservoir rock samples (e.g., training image data 330) and segmentation data (e.g., training segmentation data 332) mapping an intensity of each image element in the image data to a particular output channel, where the output channel represents a characterization of the reservoir rock for a corresponding segment of the image data. Details of training the deep learning are provided in FIG. 5.

With reference now to FIG. 5, a flowchart of an illustrative process for training a deep learning model in accordance with block 402 of FIG. 4 is shown. For discussion purposes, FIG. 5 will be described with reference to FIG. 1, the system 300 of FIG. 3, and FIG. 4. However, embodiments are not intended to be limited thereto.

In block 502, training image data and training segmentation data are obtained. As described with reference to FIG. 3, training image data and training segmentation data (e.g., collectively, “training data”) may be retrieved from a memory or storage device, such as memory 310 or database 324. Moreover, the training image data may correspond to image data of reservoir rock samples obtained from a reservoir formation and segmentation of such image data. The reservoir rock samples and image data of such samples may be obtained in accordance with embodiments described with respect to FIG. 1. Further, the training segmentation data may correspond to segmentation data generated based on the training image data and in accordance with the segmentation described with respect to FIGS. 2A-2B. To that end, the segmentation data may be generated based on a user input. In some embodiments, the training segmentation data may correspond to segmentation data generated automatically by a deep learning model (e.g., generated without user intervention), such as deep learning model 312, as described in greater detail below. In any case, the segmentation data may identify (e.g., label) the different channels, such as the pore channel, the porous medium channel, the mineral channel, and/or the like, included within the image data.

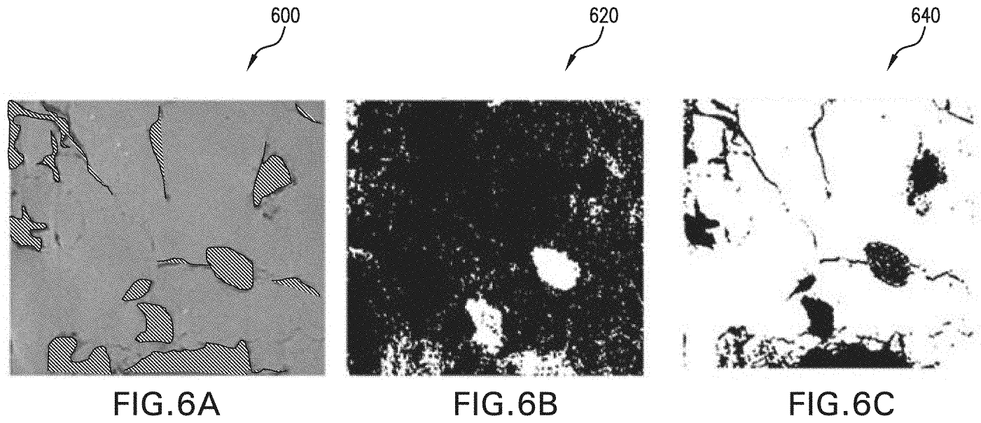

In block 504, the training segmentation data is separated into one or more binary images. As indicated by the dashed lines, the block 504 is optionally implemented and/or included to train a deep learning model. For instance, if the training segmentation data is already separated into binary images, the block 504 may not be performed. If, on the other hand, the training data includes an image depicting multiple channels (e.g., a multi-channel image) and/or a grayscale or colored image, the block 504 may be performed. Further, in some embodiments, the deep learning model may be configured to generate an output (e.g., channel outputs and/or segmentation data) as binary images. Accordingly, separation of segmentation data into binary images may enable the deep learning model to more directly map input image data to an output, as described in greater detail below. An illustrative example of a multi-channel is shown in at least FIGS. 2A-2B. Further, performance of the block 504 is described below with reference to FIGS. 6A-6C.

FIG. 6A illustrates an exemplary multi-channel image 600. More specifically, FIG. 6A illustrates a multi-channel image that includes segmentation data identifying two different channels. Further, the multi-channel image 600 represents an example of training data (e.g., training image data and training segmentation data). The segmentation data is illustrated by the differentiation between a first channel and a second channel within the multi-channel image 600. In particular, a mineral channel is indicated within certain outlined regions of the multi-channel image 600 via a striped fill pattern, while a porous medium channel is indicated as the remaining area of the multi-channel image 600. Because multi-channel image 600 illustrates segmentation data corresponding to multiple different channels (e.g., the mineral channel and the porous medium channel), the multi-channel image 600 may also be referred to as a composite image.

According to the block 504 of FIG. 5, the multi-channel image 600 may be split into its component parts (e.g., component channels or layers). In some embodiments, the separation of a particular channel from a multi-channel image (e.g., multi-channel image 600) into a binary image may be achieved by assigning image elements (e.g., pixels and/or voxels) segmented into the particular channel (e.g., indicated as corresponding to the channel in the segmentation data) a first value and assigning the remaining image elements of the image a different, second value. For instance, the segmentation data corresponding to the mineral channel may be extracted to a binary image from the multi-channel image 600) by assigning the image elements within the outlined, striped regions of the multi-channel image a first value. The mineral channel may further be extracted by assigning the remaining image elements (e.g., outside the outlined regions) a different, second value. An example of such a binary image is illustrated in FIG. 6B. More specifically, FIG. 6B illustrates a binary image 620 in which white regions are identified as being associated with the mineral channel and the remaining, black regions are identified as not being associated with the mineral channel (e.g., as instead being associated with a different channel).

The extraction and/or separation of binary images described above may be repeated for each channel included within a multi-channel image. With respect to the multi-channel image 600, for example, the extraction and/or separation may be repeated to produce a binary image corresponding to the porous medium channel. More specifically, the segmentation data corresponding to the porous medium channel may be extracted to a binary image from the multi-channel image 600 by assigning the image elements outside the outlined, striped regions of the multi-channel image 600 a first value. The porous medium channel may further be extracted by assigning the remaining image elements (e.g., within the outside the outlined, striped regions) a different, second value. An example of such a binary image is illustrated in FIG. 6C. More specifically, FIG. 6C illustrates a binary image 640 in which white regions are identified as being associated with the porous medium channel and the remaining, black regions are identified as not being associated with the porous medium channel (e.g., as instead being associated with a different channel). While a particular method of generating binary images from segmentation data is described herein, embodiments are not limited thereto. In this regard, any suitable image processing and/or filtering techniques may be used to generate the binary images.

Turning back now to FIG. 5, at block 506, the deep learning model may be trained using the training image data and the training segmentation data. More specifically, the deep learning model may be trained to map an input, such as an input image and/or image data from the training image data, to an output, such as a set of binary images (e.g., a set of output channels), which may be included in the training segmentation data. For instance, the deep learning model may be configured to identify correlations and/or patterns between image elements across a set of image data that are each mapped to a particular output channel. In some embodiments, for example, the deep learning model may, based on an evaluation of the training image data and the training segmentation data, determine that an image element with an intensity within a first range may correspond to the mineral channel, while an image element with an intensity within a second range may correspond to the pore channel. Additionally or alternatively, the deep learning model may determine that a relative intensity of an image element with respect to other image elements in an image may correspond to a particular channel. In this way, the deep learning model may account for variations in intensities of similar features (e.g., minerals, pores, porous medium, and/or the like) between different images, which may result from differences in equipment and/or imaging modalities used to obtain the images, for example. Further, because an expected output (e.g., segmentation) for a given image of the training image data may be included in the training segmentation data, the training of the deep learning model may be supervised. However, embodiments are not limited thereto. In some embodiments, for example, a deep learning model may be trained to perform unsupervised segmentation.

At block 508, the deep learning model may optionally (as indicated by the dashed lines) be retrained. In some embodiments, for example, the training of the deep learning model may be validated using a set of validation data. The validation data may be the same as or different from the training data. In some embodiments, for example, the validation data may be a subset of the training data that was not previously used to train the deep learning model (e.g., at block 506). To validate the training of the deep learning model, an input image and/or image data of the validation data may be provided to the deep learning model. Subsequently, a segmentation of the image and/or image data provided by the deep learning model may be compared against a segmentation of image and/or image data included in the validation data. In some embodiments, if a similarity (e.g., a correlation) between the segmentation by the deep learning model and the segmentation of the validation data satisfies a threshold, the deep learning model may not be retrained at block 508. If, on the other hand, the similarity fails to satisfy the threshold, the deep learning model may be retrained at block 508. Further, in some embodiments, the comparison of the segmentation of the image data by the deep learning model or of the validation data may be performed based on an individual channel or a set of output channels. To that end, a separate threshold may be used for in a respective comparison of different output channels or a single threshold may be used for a comparison between a group of output channels. Moreover, the deep learning model may be retrained based on a particular output channel or may be retrained for a set of output channels. To this end, retraining the deep learning model that includes a different deep learning model for different output channels (e.g., a first deep learning model for a first output channel, a second deep learning model for a second output channel, and so on) based on a particular channel may involve retraining the deep leaning model within the deep learning model that is trained to segment (e.g., output) the particular channel. Additionally or alternatively, the deep learning model may be retrained based on a user input, which may be received via the GUI 314, as described above. For instance, the user input may reject or adjust a segmentation of an image provided by the deep learning model, and, in response, the deep learning model may be retrained so that a subsequent segmentation of the image aligns with the adjustment made by the user.

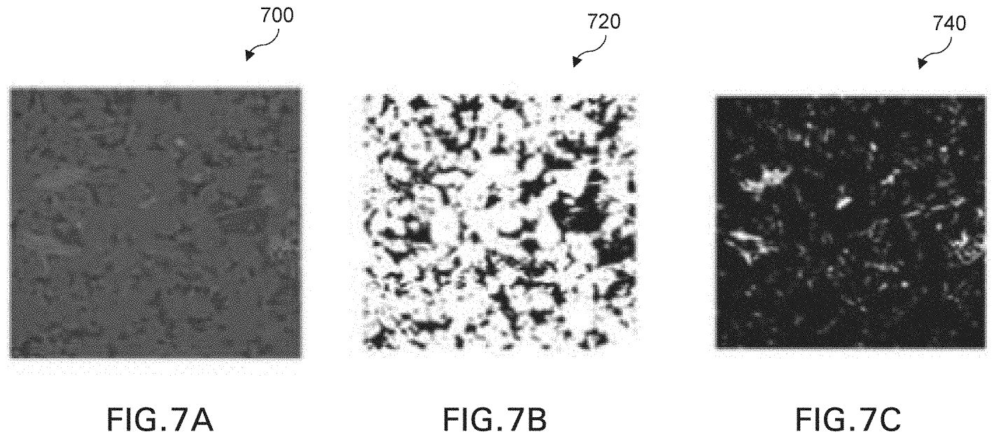

With reference now to FIG. 4, at block 404, the process 400 involves obtaining image data of a reservoir rock sample, such as sample image data 334. In some embodiments, the reservoir rock sample may be obtained from a reservoir formation, such as reservoir formation 113. To that end, the reservoir rock sample may be a core sample and/or a plug sample. Further, the image data may correspond to imaging data output by an imaging scan, such as imaging scan 117 of FIG. 1, of the sample. In this regard, the image data may include CT image data or image data corresponding to any suitable imaging modality. Moreover, the image data may include 2D images and/or 3D image data (e.g., a sequence of 2D images), as well as color, grayscale, and/or binary images. An example of an image (e.g., image data) of a reservoir rock sample is illustrated in FIG. 7A.

Further, as described with respect to FIG. 3, image data of a reservoir rock sample (e.g., sample image data 334) may be stored in memory, such as memory 310, or a database, such as database 324. In this regard, obtaining the image data may involve receiving the image data from an imaging device, such as a CT imaging device, or receiving (e.g., retrieving) the image data from a data storage device (e.g., memory).

At block 406, the process 400 involves determining an intensity of an image element of the image data of the reservoir rock sample (e.g. an image element of the sample image data). More specifically, determining an intensity of an image element may involve determining a signal intensity associated with the image element and/or a level of brightness associated with the image element. In some embodiments, the image data may include one or more color, grayscale, binary images, and/or the like. To that end, the intensity of an image element of a color, grayscale, and/or binary image may be determined. Determining the intensity of an image element of a grayscale image may include determining the grayscale value and/or color of the image element. For instance, relatively whiter image elements may correspond to a greater intensity, while relatively blacker elements may correspond to a lower intensity, or vice versa. The intensity of the image element may additionally or alternatively be determined via image processing, such as filtering of the image data, conversion of the image data to grayscale, and/or the like.

At block 408, the process 400 involves generating segmentation data, such as sample segmentation data 336) corresponding to the image data of the reservoir rock sample. The segmentation data may include one or more segmentations of the image data. That is, for example, the segmentation data may segment (e.g., label and/or classify) different areas of images within the image data based on a particular channel associated with the areas. For instance, the segmentation data may identify an area (e.g., an image element) of an image as corresponding to the pore channel, the porous medium channel, the mineral channel, and/or the like. In this regard, the segmentation data may map an intensity of image elements of the image data to a particular output channel, where the output channel represents a characterization of the reservoir rock sample for a corresponding segment of the image data. In some embodiments, the segmentation data may include a set of binary images, where each binary image corresponds to a respective output channel of the output channels included in the image data.

Further, the segmentation data may be generated using the deep learning model trained at block 402 (e.g., the trained deep learning model). In particular, the trained deep learning model may generate the segmentation data based on the intensity of the image element. For instance, based on the training of the deep learning model (e. g., at block 402), the deep learning model may be configured to map the intensity of the image element to a particular output channel. An indication of this output channel, such as a binary image corresponding to the output channel and associated with the image element, may be included in the segmentation data that is generated. In some embodiments, the segmentation data may be generated on a pixel-level and/or voxel-level (e.g., a volume element) basis. For instance, the intensity of each pixel and/or voxel included in the image data of the reservoir rock sample may be mapped to a respective output channel. The generation of segmentation data by a deep learning model is described in greater detail below with respect to FIGS. 7A-7C.

FIG. 7A is exemplary an image 700 (e.g., image data) of a reservoir rock sample. In particular, FIG. 7A illustrates a multi-channel image. In some embodiments, the image 700 may be input as image data or a portion thereof to a trained deep learning model. In some embodiments, the deep learning model may determine intensities of one or more image elements of the image 700. Additionally or alternatively the intensities of the one or more image elements may be input to the deep learning model. Further, while the image 700 is a grayscale image, it may be appreciated that the techniques described herein (e.g., the segmentation of image data) may be applied to color or any other suitable images.

Based on the input to the deep learning model, the deep learning model may provide a segmentation of the image 700. In particular, based on the intensities of the one or more image elements, the deep learning model may identify the image elements as corresponding to a particular output channel, such as a mineral output channel, a porous medium output channel, a pore channel, and/or the like. In some embodiments, the deep learning model may include a single model trained to identify image elements as corresponding to any of a set of available output channels. Additionally or alternatively, the deep learning model may include different models (e.g., different deep learning models) for each available output channel. For instance, a first model may identify image elements corresponding to a first output channel (e.g., the mineral channel), a second model may identify image elements corresponding to a second output channel (e.g., the porous medium channel), a third model may identify image elements corresponding to a third output channel (e.g., the pore channel), and/or the like. Further the different models may process the image data (e.g., determine a segmentation) in sequence or in parallel with one another.

Further, based on identifying an image element as corresponding to a particular output channel, the deep learning model may output segmentation data corresponding to the image element and the output channel. In particular, the deep learning model may output a binary image corresponding to the output channel and the image element. In this regard, FIGS. 7B-7C illustrate exemplary segmentation data generated by a trained deep learning model based on the image 700 of FIG. 7A and in accordance with the process 400 of FIG. 4.

To output segmentation data, such as the binary images illustrated in FIGS. 7B-7C, the deep learning model may assign a first value to an image element corresponding to an output channel and assign image elements of the image not corresponding to the output channel a different, second value, as similarly described above with reference to FIGS. 6B-6C. For instance, based on the multi-channel image 700, segmentation data corresponding to the porous phase channel may be output as a binary image by assigning image elements identified as corresponding to the porous medium channel a first value. The porous phase channel may further be output by assigning the image elements identified as not corresponding to the porous medium channel a different, second value. An example of such a binary image is illustrated in FIG. 7B. More specifically, FIG. 7B illustrates a binary image 720 in which white regions (e.g., image elements) are identified as being associated with the porous medium channel and the remaining, black regions are identified as not being associated with the porous medium channel (e.g., as instead being associated with a different channel). Further, based on the multi-channel image 700, segmentation data corresponding to the mineral phase channel may be output as a binary image by assigning image elements identified as corresponding to the mineral phase channel a first value. The mineral phase channel may further be output by assigning the image elements identified as not corresponding to the mineral phase a different, second value. An example of such a binary image is illustrated in FIG. 7C. More specifically, FIG. 7C illustrates a binary image 740 in which white regions (e.g., image elements) are identified as being associated with the mineral channel and the remaining, black regions are identified as not being associated with the mineral medium channel (e.g., as instead being associated with a different channel).

With reference now to FIG. 4, in some embodiments, the segmentation data generated at block 408 may be stored in association with the image data of the reservoir rock sample as training data (e.g., training data 326). The generated segmentation data and image data of the reservoir rock sample may then be subsequently used as training data for training or retraining the deep learning model. For instance, the image data of the reservoir rock sample may be used as an input to the deep learning model and may be mapped to the output of the generated segmentation data during training or retraining of the deep learning model. The generated segmentation data and image data of the reservoir rock sample may additionally or alternatively be used as training data for an additional deep learning model. For instance, the generated segmentation data and image data of the reservoir rock sample may be stored in a database, such as database 324, and may be accessed over a network (e.g., network 322) by an in communication with the network. In this way, training of the deep learning model may be propagated to an additional deep learning model.

At block 410, the process 400 involves outputting a characterization of the reservoir rock sample. In some embodiments, the characterization may be based on the generated segmentation data. In this regard, outputting the characterization may involve outputting the generated segmentation data. For instance, binary images corresponding to respective output channels, such as those illustrated in FIGS. 7A-7B, may be output. Additionally or alternatively, a composite image illustrating different output channels within an image may be output based on the generated segmentation data.

Further, in some embodiments, outputting the characterization may involve outputting an indication of a distribution of pores in the reservoir rock sample, a size of the pores in the reservoir rock sample, a model of the reservoir rock sample, a simulation of the model, and/or the like. The indication may be determined based on the generated segmentation data by data visualizer 318 and/or rock simulator 320, for example.

In some embodiments, outputting the characterization may involve outputting the classification to a data storage device, such as a memory (e.g., memory 310) and/or a database (e.g., database 324). In some embodiments, outputting the characterization may involve outputting the characterization to a display, such as an electronic display. The characterization may be displayed within a GUI, such as GUI 315, for example. Additionally or alternatively, the characterization may be output to a processing system or component, such as data visualizer 318 and/or rock simulator 320. Moreover, characterization of a reservoir rock sample may correspond to a characterization of a reservoir formation from which the sample was obtained. To that end, the output of the characterization may enable reservoir simulations and well planning.

FIG. 8 is a block diagram of an illustrative computer system 800 in which embodiments of the present disclosure may be implemented. For example, the functions, components, and/or operations of processing system 119 or memory 121 of FIG. 1, system 300 of FIG. 3, process 400 of FIG. 4, and/or the process illustrated in FIG. 5, as described above, may be implemented using system 800. System 800 can be a computer, phone, PDA, or any other type of electronic device. Such an electronic device includes various types of computer readable media and interfaces for various other types of computer readable media. As shown in FIG. 8, system 800 includes a permanent storage device 802, a system memory 804, an output device interface 806, a system communications bus 808, a read-only memory (ROM) 810, processing unit(s) 812, an input device interface 814, and a network interface 816.

Bus 808 collectively represents all system, peripheral, and chipset buses that communicatively connect the numerous internal devices of system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of system 800. Permanent storage device 802, on the other hand, is a read-and-write memory device. This device is a non-volatile memory unit that stores instructions and data even when system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for implementing the deep learning model, for training the deep learning model, and/or for performing automatic digital segmentation of a reservoir rock sample in accordance with embodiments of the present disclosure, e.g., according to the deep learning model 312 of FIG. 3, process 400 of FIG. 4, and the process illustrated in FIG. 5, as described above. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the system 800. Input devices used with input device interface 814 include, for example, alphanumeric, QWERTY, or T9 keyboards, microphones, and pointing devices (also called “cursor control devices”). Output device interfaces 706 enables, for example, the display of images generated by the system 800. Output devices used with output device interface 806 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 8, bus 808 also couples system 800 to a public or private network (not shown) or combination of networks through a network interface 816. Such a network may include, for example, a local area network (“LAN”), such as an Intranet, or a wide area network (“WAN”), such as the Internet. Any or all components of system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, process 400 of FIG. 4, as described above, may be implemented using system 800 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for automatically and digitally characterizing reservoir rock samples. In one embodiment of the present disclosure, a computer-implemented method for characterizing reservoir rock includes: training a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data; obtaining second image data of a new reservoir rock sample; determining an intensity of each image element of the second image data; generating, using the trained deep learning model, second segmentation data mapping the intensity of each image element in the second image data to a corresponding one of the plurality of output channels of the trained deep learning model; and utilizing the trained deep learning model to output a characterization of the new reservoir rock sample, based on the second segmentation data generated for the second image data.

In one or more embodiments of the foregoing computer-implemented method: the plurality of output channels includes at least one of a mineral channel, a pore channel, and a porous medium channel; the first segmentation data includes a plurality of binary images, where each of the plurality of binary images corresponds to a respective one of the plurality of output channels; the method includes generating the first segmentation data, where the generating the first segmentation data includes separating a multi-channel image into the plurality of binary images based on a segmentation of the multi-channel image; the second image data includes three-dimensional (3D) image data of the new reservoir rock sample: the 3D image data includes a sequence of two-dimensional (2D) images; each image element is a voxel representing a corresponding volume of the reservoir rock in the respective first and second image data; the generating the second segmentation data includes: generating, using the trained deep learning model, a binary image corresponding to at least one image element of the second image data and the corresponding one of the plurality of output channels; the deep learning model includes a three-dimensional U-Net model; the method further involves outputting the second segmentation data to a data storage device; and the characterization of the new reservoir rock sample includes an indication of a distribution of pores in the new reservoir rock sample, a size of the pores in the new reservoir rock sample, or a model of the new reservoir rock sample.

In one embodiment of the present disclosure, a system is disclosed, where the system includes: a processor; and a memory having processor-readable instructions stored therein, which, when executed by the processor, cause the processor to perform a plurality of functions, including functions to; train a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data; obtain second image data of a new reservoir rock sample; determine an intensity of each image element of the second image data; generate, using the trained deep learning model, second segmentation data mapping the intensity of each image element in the second image data to a corresponding one of the plurality of output channels of the trained deep learning model; and utilize the trained deep learning model to output a characterization of the new reservoir rock sample, based on the second segmentation data generated for the second image data.

In one or more embodiments of the foregoing system the plurality of output channels includes at least one of a mineral channel, a pore channel, and a porous medium channel; the first segmentation data includes a plurality of binary images, where each of the plurality of binary images corresponds to a respective one of the plurality of output channels; the plurality of functions further includes functions to: generate the first segmentation data, where the generating the first segmentation data includes separating a multi-channel image into the plurality of binary images based on a segmentation of the multi-channel image; the second segmentation data includes a binary image corresponding to at least one image element of the second image data and the corresponding one of the plurality of output channels; the deep learning model includes a three-dimensional U-Net model; the plurality of functions further includes functions to: output the second segmentation data to a data storage device; where the characterization of the new reservoir rock sample includes an indication of a distribution of pores in the new reservoir rock sample, a size of the pores in the new reservoir rock sample, or a model of the new reservoir rock sample.

In another embodiment of the present disclosure, a computer-readable storage medium having computer-readable instructions stored therein, which, when executed by a computer, cause the computer to perform a plurality of functions, including functions to: train a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data; obtain second image data of a new reservoir rock sample; determine an intensity of each image element of the second image data; generate, using the trained deep learning model, second segmentation data mapping the intensity of each image element in the second image data to a corresponding one of the plurality of output channels of the trained deep learning model, and utilize the trained deep learning model to output a characterization of the new reservoir rock sample, based on the second segmentation data generated for the second image data.

While specific details about the above embodiments have been described, the above hardware and software descriptions are intended merely as example embodiments and are not intended to limit the structure or implementation of the disclosed embodiments. For instance, although many other internal components of the system 800 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method for characterizing reservoir rock, the method comprising:
training a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data;
obtaining second image data of a new reservoir rock sample;
determining an intensity of each image element of the second image data;
generating, using the trained deep learning model, second segmentation data mapping the intensity of each image element in the second image data to a corresponding one of the plurality of output channels of the trained deep learning model; and
utilizing the trained deep learning model to output a characterization of the new reservoir rock sample, based on the second segmentation data generated for the second image data.

2. The computer-implemented method of claim 1, wherein the plurality of output channels comprises at least one of a mineral channel, a pore channel, and a porous medium channel.

3. The computer-implemented method of claim 1, wherein the first segmentation data comprises a plurality of binary images, wherein each of the plurality of binary images corresponds to a respective one of the plurality of output channels.

4. The computer-implemented method of claim 3, comprising:
generating the first segmentation data, wherein the generating the first segmentation data comprises separating a multi-channel image into the plurality of binary images based on a segmentation of the multi-channel image.

5. The computer-implemented method of claim 1, wherein the second image data comprises three-dimensional (3D) image data of the new reservoir rock sample.

6. The computer-implemented method of claim 5, wherein the 3D image data comprises a sequence of two-dimensional (2D) images.

7. The computer-implemented method of claim 1, wherein each image element is a voxel representing a corresponding volume of the reservoir rock in the respective first and second image data.

8. The computer-implemented method of claim 1, wherein the generating the second segmentation data comprises:
generating, using the trained deep learning model, a binary image corresponding to at least one image element of the second image data and the corresponding one of the plurality of output channels.

9. The computer-implemented method of claim 1, wherein the deep learning model comprises a three-dimensional U-Net model.

10. The computer-implemented method of claim 1, further comprising outputting the second segmentation data to a data storage device.

11. The computer-implemented method of claim 1, wherein the characterization of the new reservoir rock sample comprises an indication of a distribution of pores in the new reservoir rock sample, a size of the pores in the new reservoir rock sample, or a model of the new reservoir rock sample.

12. A system comprising:
a processor; and
a memory having processor-readable instructions stored therein, which, when executed by the processor, cause the processor to perform a plurality of functions, including functions to:
train a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data;
obtain second image data of a new reservoir rock sample;
determine an intensity of each image element of the second image data;
generate, using the trained deep learning model, second segmentation data mapping the intensity of each image element in the second image data to a corresponding one of the plurality of output channels of the trained deep learning model; and
utilize the trained deep learning model to output a characterization of the new reservoir rock sample, based on the second segmentation data generated for the second image data.

13. The system of claim 12, wherein the plurality of output channels comprises at least one of a mineral channel, a pore channel, and a porous medium channel.

14. The system of claim 12, wherein the first segmentation data comprises a plurality of binary images, wherein each of the plurality of binary images corresponds to a respective one of the plurality of output channels.

15. The system of claim 14, wherein the plurality of functions further includes functions to:
generate the first segmentation data, wherein the generating the first segmentation data comprises separating a multi-channel image into the plurality of binary images based on a segmentation of the multi-channel image.

16. The system of claim 12, wherein the second segmentation data comprises a binary image corresponding to at least one image element of the second image data and the corresponding one of the plurality of output channels.

17. The system of claim 12, wherein the deep learning model comprises a three-dimensional U-Net model.

18. The system of claim 12, wherein the plurality of functions further includes functions to:
output the second segmentation data to a data storage device.

19. The system of claim 12, wherein the characterization of the new reservoir rock sample comprises an indication of a distribution of pores in the new reservoir rock sample, a size of the pores in the new reservoir rock sample, or a model of the new reservoir rock sample.

20. A computer-readable storage medium comprising computer-readable instructions stored therein, which, when executed by a computer, cause the computer to perform a plurality of functions, including functions to:
train a deep learning model to segment digital images of reservoir rock using first image data of a set of reservoir rock samples and first segmentation data mapping an intensity of each image element of the first image data to one of a plurality of output channels, each of the plurality of output channels representing a different characterization of the reservoir rock for a corresponding segment of the first image data;
obtain second image data of a new reservoir rock sample;
determine an intensity of each image element of the second image data;
generate, using the trained deep learning model, second segmentation data mapping the intensity of each image element in the second image data to a corresponding one of the plurality of output channels of the trained deep learning model; and
utilize the trained deep learning model to output a characterization of the new reservoir rock sample, based on the second segmentation data generated for the second image data.
